(19) United States
(12) Patent Application Publication
(10) Pub. No.: US 2025/0092277 A1
(43) Pub. Date: Mar. 20, 2025

(54) Universal Dispersant For Inorganic And Organic Pigments

(71) Applicant: Clariant International Ltd, Muttenz (CH)

(72) Inventors: Matthias HAEUSSLER, Hochheim (DE); Simon ABEN, Frankfurt am Main (DE); Jan SCHNEIDER, Salz (DE); Joerg Rueger, Mainz-Kostheim (DE)

(73) Assignee: Clariant International Ltd, Muttenz (CH)

(21) Appl. No.: 18/562,248

(22) PCT Filed: Jan. 20, 2022
(86) PCT No.: PCT/EP2022/051180

§ 371 Date: Nov. 17, 2023

(30) Foreign Application Priority Data
May 20, 2021 (EP) 21174871.0

(51) Int. Cl. C09D 17/00; C09D 7/45; C09D 7/65; C09D 133/14

(52) U.S. Cl. CPC C09D 17/001; C09D 7/45; C09D 7/65; C09D 17/003; C09D 17/004; C09D 133/14

(57) ABSTRACT

Disclosed herein is a pigment preparation including at least one organic and/or inorganic pigment and/or filler. The pigment preparation further includes at least one anionic copolymer as dispersant, containing 40 to 95 mol % of structural units of an anionic monomer selected from the group consisting of acrylic acid, methacrylic acid, itaconic acid, 2-carboxyethylacrylic acid, maleic acid, mixtures thereof and their respective salts, and further containing 5 to 60 mol % of structural units of a monomer having repeat units of formula (B1)

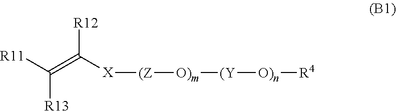

where R11, R12 and R13 are, independently, selected from the group consisting of H, methyl and ethyl; R4 is H or an alkyl group having 1 to 4 carbon atoms; X is selected from the group consisting of O, COO, CONH, CH₂O and CH₂CH₂O; Y is an ethylene group; Z is a propylene group, a butylene group or a phenylethylene group; m is an integer from 0 to 100; n is an integer from 1 to 100; and m+n is greater than 5. The pigment preparation also includes at least one nonionic copolymer, containing at least one structural unit having aromatic groups and at least one structural unit having polyethylene glycol groups. The pigment preparation also includes water.

The present invention relates to preparations or dispersions of water-based inorganic and organic pigments, to processes for producing them and to their use for coloring natural and synthetic materials of all kinds, especially coating materials, paints, varnishes, stains, wood preservative systems and inks.

Inorganic pigments consist primarily of minerals or metal salts such as chromates, metal oxides, sulfates, sulfides, carbonates and cyanides. They are widespread in industry on account of their lightfastness and low costs. Organic pigments, conversely, consist customarily of carbon rings and chains and exhibit a brighter, fuller color and a higher color strength. Both types of pigment are solid particles, but on account of their different natures have different surface chemistries. In order to use pigments in the formulations described above, it is necessary to use specific surface-active substances such as wetting and dispersing assistants in order to alter the surface chemistry and to enable effective dispersion of the pigment particles. According to the known mechanisms of particle stabilization, the wetting and dispersing assistants used enable effective steric and/or electrostatic stabilization of the dispersed particles in these application media, without flocculation or reagglomeration of the pigment particles.

There is a need for provision of aqueous pigment products for the applications stated above that meet the demanding technical requirements in terms in particular of particle size distribution, compatibility and miscibility with the respective application medium, coloristic properties, pigment content, rheology profile and stability.

The foaming propensity also in compliance with the regulatory requirements, in relation to the toxicological and ecotoxicological profile, for example, is an increasing challenge for the industry.

The reason for this in particular is that the progressive tightening of chemicals legislation and the issuing of eco labels, for example the German Blue Angel or the European eco label, are meaning that, increasingly, common formulation components for pigment products can no longer be used, or can be used only to a limited degree for certain areas of use. This applies in particular to the wetting agents and dispersants. For example, alkylphenol ethoxylates (APEOs) are now strictly regulated and proscribed for many uses, on account of bioaccumulative and hormonal degradation products. Although the use of tristyrylphenol ethoxylates (TSPEOs) is still possible, there is nevertheless a strong trend in the industry to shun TSPEOs, owing to the adverse ecotoxicological profile. The use of novolac- or bisphenol A-based dispersants which were used in the past is limited for the same reasons. The use of alkoxylated reaction products based on primary and secondary amines as dispersants is likewise questionable for certain applications, for regulatory and technical reasons, and therefore possible only to a limited degree.

Described in the prior art are aqueous pigment preparations which contain various dispersing assistants for which a universal effect is claimed for organic or inorganic pigments.

U.S. Pat. No. 5,340,394 describes pigment concentrates based on polyethylene glycol polyethers having low molecular weights of 200 to 700 in conjunction with nonionic alkylglycoside surfactants.

WO-2020/152093 teaches aqueous pigment preparations comprising (A) at least one organic and/or inorganic pigment and/or filler, (B) at least one dispersant of the formula (I) or (II), or mixtures of the dispersants of the formulae (I) and (II),

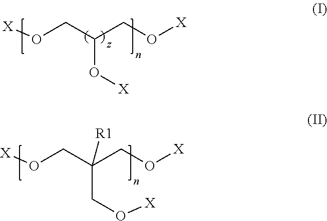

where n is an integer greater than or equal to 1, preferably 1 to 5, more preferably 1 to 2, z is an integer greater than or equal to 1, preferably 1 to 10, more preferably 1 to 4, R1 is an aliphatic, linear or branched hydrocarbon radical having 1 to 10 carbon atoms or is a hydrogen atom or is the structural unit —O—X or the structural unit —CH₂—O—X, and structural unit X corresponds to the formula (III).

DE-10 2005 019 384 teaches a polymer of the formula (I),

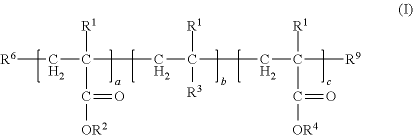

in which: R1: each independently H or an alkyl group having 1 to 6 carbon atoms; R2: H, an alkyl group having 1 to 8 carbon atoms, an alkali metal ion, an alkaline earth metal ion, an ammonium ion or the residue of any other base; R3: an aryl group or an aralkyl group having 6 to 18 carbon atoms; R4, R5: H or an alkyl group having 1 to 6 carbon atoms; R6, R7: each independently: H or methyl; R8, R9: H or any terminal group; a: 0.1 to 0.9; b: 0.9 to 0.1; c: 0.001 to 0.5; m: 1 to 4; n: 1 to 150. The polymer of the invention is suitable especially as a dispersant for pigments or fillers in varnishes.

DE-930655U1 teaches an aqueous, non-clogging tinting color for paints or similar coating compositions, said tinting color having a viscosity at 20° C. of 0.05 to 1.5 Ns/m² (i.e. 0.5 to 15 poise and preferably 1 to 12 poise) and containing solid pigment particles present in dispersion in a dispersion medium system which consists of a mixture of water and a water-miscible, nonvolatile, micellizing dispersant that contains hydrophilic moieties and moieties (which are customarily less hydrophilic than the hydrophobic moieties) capable of adsorption onto the surface of the pigment, where
a) the dispersion medium system also contains a relatively small amount (of less than 50 wt % and preferably less than 30 wt %, based on the weight of the dispersion medium system) of a nonvolatile, macromolecular, nonmicellizing auxiliary material having a weight average molecular weight of 230 (preferably 250) to 4500 and being selected from
   i) liquids which are miscible with the mixture of water and the nonvolatile dispersant, and/or
   ii) particulate organic solids having a melting point of below 150° C. that are soluble or dispersible in the system,
b) for a selected weight of the pigment, the weight ratio of the nonvolatile micellizing dispersant to the pigment is at least 5% (and preferably 15%) greater than the weight ratio of the nonvolatile micellizing dispersant to the pigment that would be present at the Daniel flow point of a reference tinting color consisting only of the same pigment, the water and the same nonvolatile micellizing dispersant,
c) the flowability of the tinting color is such that, when the non-clogging tinting color has been stored at 25° C. for 18 h in a cylindrical hole having a diameter of 2 mm and a length of 15 mm at an ambient relative humidity of 50%, a pressure of not more than 320 MN/m² is sufficient to cause the rest of the tinting color to flow out of the hole, and
d) “nonvolatile” stands for a vapor pressure of below 1.3 N/m² (and preferably below 1.0 N/m²) at 25° C.

EP-1092756 teaches a pigment preparation comprising a pigment and/or carbon black and a polymer and/or a surfactant from the series of crosslinked polyoxyethyleneacrylic acid, fatty alcohol polyglycol ethers, polyvinylpyrrolidones, alcohol alkoxylates, lignosulfonates, alkylphenol polyglycol ethers, naphthalenesulfonic acid derivatives or mixtures thereof which is produced by freeze drying from aqueous dispersion. It may be used for coloring and/or antistatic treatment in waterborne paint and varnish systems, in emulsion paints, printing inks, liquid-ink systems and coating systems.

WO-2009/145285 teaches a recording ink comprising a colorant dispersion comprising:
a coloring agent and
water,
wherein the dispersant is a polycarboxylic acid dispersant containing units represented by the formulae (1) to (3):

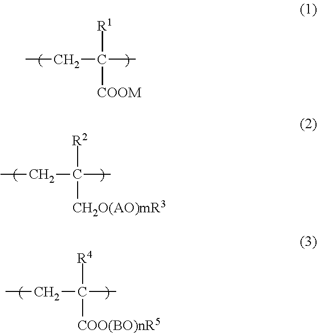

in which R¹, R² and R⁴ are selected from a hydrogen atom and CH₃; R³ is selected from a hydrogen atom and a C1-C3 alkyl group; R⁵ is a C1-C3 alkyl group; AO and BO are a C2-C3 oxyalkylene group; M is selected from alkali metal, alkaline earth metal, ammonium and organic amine; m is an integer from 1 to 30; and n is an integer from 5 to 50, and where the coloring agent is any one of a black pigment, a magenta pigment, a cyan pigment and a yellow pigment.

U.S. Pat. No. 7,659,340 teaches pigment pastes using a surfactant mixture which comprises at least one alkyd-compatible surfactant and at least one latex-compatible surfactant.

WO-2014/000842 describes aqueous pigment preparations which comprise fatty acid condensation products and nonionic surfactants as dispersing assistants.

US-2018/244925 teaches pigment formulations which comprise water-soluble, nonionic, surface-active copolymers based on carboxylic esters and/or carboxamides and a phosphoric or phosphoric acid surfactant as dispersing assistant.

From the prior art it is evident that universal dispersing properties are achievable only by using water-soluble surfactants as a component of the pigment formulation. Such water-soluble surfactants, however, have a low molecular weight, can easily migrate to the surface of coatings, and therefore frequently tend to surfactants being leached out if they are used in aqueous coating compositions such as waterborne paints. Such leaching is visible on the surface of drying or dried paints, in the form of vertical marks (known generally as “snail trails”) in cold and damp atmospheres. On the other hand, it was shown by Gabel in European Coatings Journal 02-2019, pp. 90-94, that the relatively high molecular weight and the chemical structure of polymeric dispersants give them less of a tendency toward leaching. This is a result of their customary multiple adhesion points on the pigment surface and their relatively low mobility within the paint and varnish formulation, owing to slower Brownian molecular movement and interentangling of the polymer chains with other paint and varnish constituents.

It is very clear that in spite of the prior art described, there is still a need for universal dispersing assistants for pigment formulations with improved performance. The pigment formulations ought to have an extremely high color strength. Furthermore, on prolonged storage they ought to remain stable and not be thixotropic.

It has now surprisingly been found that a combination of two polymeric dispersants is able to achieve stable, universal formulations of inorganic and/or organic pigments that exhibit the desired properties in the aforementioned coloring applications, especially a ready dispersibility and high color strength at low formulation viscosities. Furthermore, it has surprisingly been found that the combination of two polymeric dispersants shows synergistic effects in pigment preparations that are not obtained from the individual components.

As a first subject, the present invention relates to a pigment preparation containing
(A) at least one organic and/or inorganic pigment and/or filler;
(B) at least one anionic copolymer as dispersant, which contains
   (I) 40 to 95 mol % of structural units of an anionic monomer which is selected from the group consisting of acrylic acid, methacrylic acid, itaconic acid, 2-carboxyethylacrylic acid, maleic acid, mixtures thereof and their respective salts, preferably methacrylic acid or its salt, and
   (II) 5 to 60 mol % of structural units of a monomer having repeat units of formula (B1)

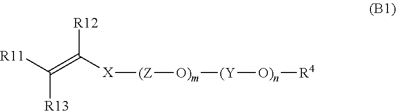

in which
R11, R12 and R13 independently of one another are selected from the group consisting of H, methyl and ethyl,
R4 is H or an alkyl group having 1 to 4 carbon atoms,
X is selected from the group consisting of O, COO, CONH, CH₂O or CH₂CH₂O,
Y is an ethylene group
Z is a propylene group, a butylene group or a phenylethylene group,
m is an integer from 0 to 100,
n is an integer from 1 to 100, and
m+n is greater than 5, and
(C) at least one nonionic copolymer, which contains at least one structural unit having aromatic groups and at least one structural unit having polyethylene glycol groups, and
(H) water.

The pigment preparation of the invention may optionally also contain further constituents as follows:
(D) wetting agents,
(E) further surfactants and/or dispersants,
(F) one or more organic solvents and/or one or more hydrotropic substances and/or mixtures thereof, and
(G) further additives customary for the production of aqueous pigment dispersions.

Preferred pigment preparations contain 5 to 80 wt %, preferably 10 to 70 wt %, especially preferably 30 to 70 wt % of component (A).

Preferred pigment preparations contain 0.1 to 30 wt %, preferably 1 to 20 wt %, especially preferably 2 to 15 wt % of component (B).

Preferred pigment preparations contain 0.1 to 30 wt %, preferably 1 to 20 wt %, especially preferably 2 to 15 wt % of component (C).

Preferred pigment preparations contain water ad 100 wt %.

Particularly preferred pigment products comprise constituents in proportions as follows:
(A) 5 to 80 wt %, more particularly 10 to 70 wt %,
(B) 0.1 to 30 wt %, more particularly 1 to 20 wt %,
(C) 0.1 to 30 wt %, more particularly 1 to 20 wt %,
(D) 0 to 10 wt %, more particularly 0.1 to 5 wt %,
(E) 0 to 20 wt %, more particularly 1 to 10 wt %,
(F) 0 to 30 wt %, more particularly 5 to 20 wt %,
(G) 0 to 20 wt %, more particularly 0.1 to 5 wt %,
   based in each case on the total weight (100 wt %) of the pigment preparation.

In the event that the pigment preparation of the invention comprises one or more of components (D), (E), (F) and (G), the minimum concentration thereof independently of one another is preferably at least 0.01 wt %, more particularly at least 0.1%, based on the total weight of the pigment preparation.

### Component (A)

Component (A) of the pigment preparation of the invention is a finely divided organic or inorganic pigment or a filler, or a mixture of different organic and/or inorganic pigments and/or fillers. Component (A) may also be a dye which is soluble in certain solvents and pigmented in other solvents. The pigments may be used both in the form of dry powder and as water-moist presscakes.

The organic pigments used are preferably
monoazo, disazo, laked azo, β-naphthol, naphthol AS, benzimidazolone, disazo condensation, azo metal complex pigments and polycyclic pigments such as phthalocyanine, quinacridone, perylene, perinone, thioindigo, anthanthrone, anthronone, anthraquinone, isoviolanthrone, pyranthrone, dioxazine, quinophthalone, isoindolinone, isoindoline and diketopyrrolopyrrole pigments or carbon blacks; carbon black pigments, such as gas blacks or furnace blacks, for example; monoazo and disazo pigments, especially the color index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Yellow 219, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; β-naphthol and naphthol AS pigments, especially the color index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38 or Pigment Brown 1; laked azo and metal complex pigments, especially the color index pigments Pigment Red 48:2, Pigment Red 48:3, Pigment Red 48:4, Pigment Red 57:1, Pigment Red 257, Pigment Orange 68 or Pigment Orange 70; benzimidazoline pigments, especially the color index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72 or Pigment Brown 25; isoindolinone and isoindoline pigments, especially the color index pigments Pigment Yellow 139 or Pigment Yellow 173; phthalocyanine pigments, especially the color index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7 or Pigment Green 36; anthanthrone, anthraquinone, quinacridone, dioxazine, indanthrone, perylene, perinone and thioindigo pigments, especially the color index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 or Pigment Orange 43; triarylcarbonium pigments, especially the color index pigments Pigment Red 169, Pigment Blue 56 or Pigment Blue 61; diketopyrrolopyrrole pigments, especially the color index pigments Pigment Red 254, Pigment Red 255, Pigment Red 264, Pigment Red 270, Pigment Red 272, Pigment Orange 71, Pigment Orange 73, Pigment Orange 81.

Also suitable are laked dyes such as Ca, Mg and Al lake pigments of dyes containing sulfonic and/or carboxylic acid groups.

Examples of suitable inorganic pigments are titanium dioxides, zinc sulfides, zinc oxides, iron oxides, magnetites, manganese iron oxides, chromium oxides, ultramarine, nickel or chromium antimony titanium oxides, manganese titanium rutile, cobalt oxides, mixed oxides of cobalt and aluminum, rutile mixed-phase pigments, sulfides of rare earths, spinels of zinc and cobalt with nickel, iron- and chromium-based spinels with copper zinc and also manganese, bismuth vanadates, and mixed pigments. Used in particular are the color index pigments Pigment Yellow 184, Pigment Yellow 53, Pigment Yellow 42, Pigment Yellow Brown 24, Pigment Red 101, Pigment Blue 28, Pigment Blue 36, Pigment Green 50, Pigment Green 17, Pigment Black 11, Pigment Black 33 and Pigment White 6. Often also used preferably are mixtures of inorganic pigments. Also used typically are mixtures of organic with inorganic pigments.

Examples of suitable fillers are finely divided ores, minerals and low-solubility or insoluble salts such as carbonates, calcium carbonate, dolomite, silicon dioxide, quartz, cristobalite, kieselguhr, silicates, aluminum silicates, silicas, talc, kaolin, mica, feldspar and barium sulfate. Filler mixtures are frequently also used with preference. Also frequently used are mixtures of organic and/or inorganic pigments with fillers. Formulations which contain only one or more fillers are used, for example, for the mixing of pigment preparations in order to establish the desired profile of properties such as pigment content, rheology, density or compatibility.

### Component (B)

(B) is an anionic copolymer containing at least the structural units (I) and (II).

The structural unit (I) of (B) in one preferred embodiment is acrylic acid or methacrylic acid, or salts thereof, more preferably methacrylic acid or salts thereof.

In general, the fraction of the structural units (I) is from 40 to 95 mol %, preferably from 45 to 85 mol %.

Salts of the structural unit (I) of (B) in one preferred embodiment are alkali metal salts, more particularly sodium or potassium salts, and also ammonium salts.

The structural unit (II) of (B) corresponds to the formula (B1). In general, the fraction of the structural units (II) is from 5 to 60 mol %, preferably from 15 to 55 mol %.

In formula (B1), R11, R12 and R13 preferably independently of one another are selected from the group consisting of H or methyl. Especially preferably, R12 is methyl. Especially preferably, R11 and R13 are H.

In formula (B1), R4 is preferably H or a methyl group. Especially preferably, R4 is H.

In formula (B1), X is preferably O or C(O)O. More preferably, X is C(O)O and R12 is methyl.

In formula (B1), Z is preferably propylene and phenylethylene. With a phenylethylene group, the structural unit (Z—O) corresponds to the formula (2)

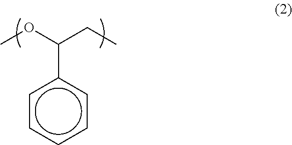

In formula (B1), m is an integer from 0 to 100, preferably an integer from 1 to 10, more preferably from 2 to 5, such as 3 or 4, for example.

In formula (B1), n is an integer from 1 to 100, preferably an integer from 5 to 45. Especially preferably, n is an integer from 8 to 14.

In formula (B1), (m+n) is preferably an integer from 8 to 49. Especially preferably, (m+n) is an integer from 11 to 18.

### Component (C)

Component (C) is (C) a nonionic copolymer containing at least one structural unit having aromatic groups and at least one structural unit having polyoxyethylene groups. Component (C) has the effect of a dispersant for organic or inorganic pigments.

In one preferred embodiment, the copolymer (C) comprises not only at least one structural unit having polyoxyethylene groups but also a structural unit having aromatic groups which derive from styrene oxide.

Particularly preferred are copolymers (C) as are described in WO-2020/152093. In this particularly preferred embodiment, the copolymers (C) correspond to the formula (3), the formula (4), or mixtures thereof

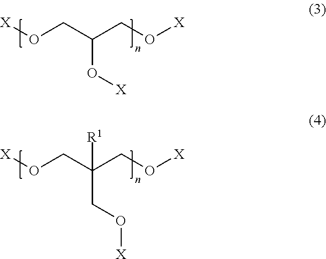

where
n is an integer greater than or equal to 1, preferably equal to 1,
R¹ is an aliphatic, linear or branched hydrocarbon radical having 1 to 10 carbon atoms, a hydrogen atom, the structural unit —O—X, or the structural unit —CH₂—O—X, preferably a hydrogen atom,
X corresponds to the formula (5)

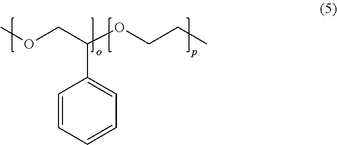

in which
o is an integer from 1 to 50, preferably is an integer from 1 to 4,
p is an integer from 1 to 200, preferably is an integer from 10 to 25, and
(o+p) is greater than 2, preferably is an integer from 2 to 250.

Especially preferably, (o+p) is an integer from 11 to 29.

Particularly preferred are copolymers (C) of styrene and maleic anhydride that are modified with polyetheramines, as are described in DE-102007032185. In this particularly preferred embodiment, the copolymers (C) correspond to the formula (6)

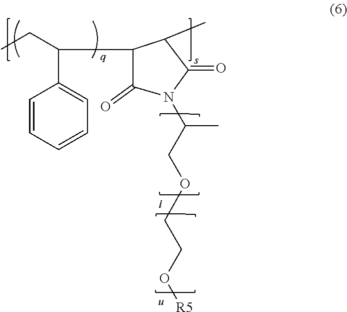

in which
q is an integer from 1 to 4, more preferably is an integer from 1 to 2
S is an integer from 5 to 50, more preferably is an integer from 5 to 20,
R5 is H or an alkyl group having 1 to 4 carbon atoms, more preferably methyl,
t is an integer from 0 to 10, more preferably is an integer from 1 to 4,
u is an integer from 1 to 100, more preferably is an integer from 10 to 50, and
t+u is greater than 10.

On account of their nonionic properties, copolymers of type (C) may be used almost exclusively for organic pigment formulations and frequently do not work with inorganic pigments.

### Component (D)

Used as component (D) for example are cationic, anionic, amphoteric or non-ionogenic compounds which promote pigment wetting (wetting agents). These are preferably so-called substrate wetting agents or levelling assistants based on fluoro surfactants, modified fluoro-acrylates or organically modified silicones.

### Component (E)

Used as component (E) of the pigment preparations of the invention are customary dispersants and surfactants or mixtures of such substances that are suitable for the production of aqueous pigment dispersions. Used customarily for this purpose are anionic, cationic, amphoteric or nonionic surfactants. It has proven particularly successful that dispersants contain one or more medium-chain or long-chain or a number of hydrocarbon chains having aromatic ring groups. Examples thereof are alkyl sulfates such as lauryl sulfate, stearyl sulfate or octadecyl sulfate, primary alkylsulfonates such as dodecylsulfonate and secondary alkylsulfonates, especially the sodium salt of C₁₃-C₁₇ alkanesulfonate; alkyl phosphates, alkylbenzenesulfonates such as dodecylbenzenesulfonic acid and also all salts of these compounds. Further suitable as component (E) of the pigment preparations of the invention are soy lecithin and condensation products of fatty acids and taurine or hydroxyethanesulfonic acid, and also alkoxylation products of castor oil resin esters, fatty alcohols, fatty amines, fatty acids and fatty acid amides. These alkoxylation products may also be ionic and comprise as end groups, for example, sulfosuccinic monoesters, sulfonic, sulfuric and phosphoric esters, and salts thereof, sulfonates, sulfates or phosphates. Also suitable are nonionic copolymers which are prepared using macromonomers of polyethylene glycol mono(meth)acrylic esters or polypropylene glycol mono(meth)acrylic esters, and, similarly, anionically modified block copolymers consisting of styrene oxide and polyalkylene oxide units.

### Component (F)

Component (F) corresponds to organic solvents, hydrotropes or retention agents which act as solubilizers or increase resistance to drying up. These may be, for example, the following compounds or a mixture thereof: monohydric or polyhydric alcohols, their ethers and esters, examples being alkanols, especially with 1 to 4 carbon atoms, such as, for example, methanol, ethanol, propanol, isopropanol, butanol, isobutanol; di- or trihydric alcohols, especially with 2 to 5 carbon atoms, e.g., ethylene glycol, propylene glycol, 1,3-propanediol, 1,4-butanediol, 1,5-pentanediol, 1,6-hexanediol, 1,6,6-hexanetriol, glycerol, diethylene glycol, dipropylene glycol, triethylene glycol, polyethylene glycol, tripropylene glycol, polypropylene glycol; lower alkyl ethers of polyhydric alcohols, such as ethylene glycol monomethyl, ethyl or butyl ether, triethylene glycol monomethyl or ethyl ether, for example; ketones and ketone alcohols such as acetone, methyl ethyl ketone, diethyl ketone, methyl isobutyl ketone, methyl pentyl ketone, cyclopentanone, cyclohexanone, diacetone alcohol; copolymers of ethylene and propylene glycol.

### Component (G)

Component (G) encompasses a series of different additives such as, for example, rheology-modifying additives or antisettling agents, which are beneficial to the viscosity and rheology. As agents for regulating the viscosity, compounds such as polyvinyl alcohol and cellulose derivatives may be used. Water-soluble natural or synthetic resins and polymers as film-formers or binders for increasing the adhesion strength and abrasion resistance may likewise be contemplated. Organic or inorganic bases and acids are used as pH regulators. Preferred organic bases are amines, e.g., ethanolamine, diethanolamine, triethanolamine, N, N-dimethylethanolamine, diisopropylamine, aminomethylpropanol or dimethylaminomethylpropanol. Preferred inorganic bases are sodium hydroxide, potassium hydroxide, lithium hydroxide or ammonia. Fats and oils of plant and animal origin may also correspond to component (G), examples being bovine tallow, palm kernel fat, coconut fat, rapeseed oil, sunflower oil, linseed oil, palm oil, soy oil, groundnut oil, whale oil, cottonseed oil, corn oil, poppy oil, olive oil, castor oil, safflower oil, soya oil, herring oil and sardine oil. The saturated and unsaturated fatty acids as well are relatively frequent additives, e.g., palmitic acid, capric acid, myristic acid, lauric acid, stearic acid, oleic acid, linoleic acid, linolenic acid, caproic acid, caprylic acid, arachidic acid, behenic acid, palmitoleic acid, gadoleic acid, erucic acid and ricinoleic acid, and also salts thereof, are used as pigment surface modifiers.

Furthermore, light stabilizers may be used, such as, for example, derivatives of benzotriazole, camphor, hydroxybenzophenone, hydroxyphenyltriazine, oxalanilides, salicylic acid or cinnamic acid, and radical scavengers such as hindered-amine light stabilizers (HALS), for example. Derivatives based on tetramethylpiperidine find application, as do antioxidants based on citric acid. Component G may also embrace the range of the defoamers based on mineral oil or on silicone derivatives.

### Component (H)

Water, component (H), which is used for producing the pigment preparations is preferably used in the form of distilled or deionized water. Potable water (mains water) and/or water of natural origin may likewise be used.

The pigment preparations have a high color strength and little propensity to foam. They have a viscosity of less than 1.0 Pas, preferably less than 0.7 Pas and more preferably less than 0.5 Pas. The pigment preparations may be mixed with alcohols of different chain lengths, preferably ethanol, in any proportion, without coagulation or flocculation of the pigment particles. The pigment preparations enjoy good storage stability.

Furthermore, the pigment preparations of the invention may be produced free of alkylphenol, tristyrylphenol, novolac and bisphenol A derivatives and also of primary and secondary amines.

The present invention also relates to a process for producing such pigment preparations, by introducing component (A) in the form of powder, granules or aqueous presscake in the presence of water (H) and components (B) and (C), and carrying out dispersion optionally with (D), (E), (F) and (G), with the aqueous pigment dispersion obtained being optionally diluted with water (H). The pigment and the mixtures of components (B) and (C) are dispersed using a dispersing unit or combinations of different dispersing units, preferably a stirred ball mill, which is operated at a peripheral stirrer velocity of 10 m/s and below the action of nonmetallic grinding media having a diameter of less than or equal to 1.2 mm, preferably smaller than or equal to 0.8 mm, which are finely divided or finely divided in the presence of water. The other additives may be present and/or added subsequently in the dispersing step.

The invention also relates to the use of the pigment preparations of the invention as colorants for pigmenting and dyeing natural and synthetic materials of all kinds, especially aqueous coating materials, inks, emulsion paints and other paints (waterborne paints), water-thinnable paints, stains, varnishes and wood preservation systems, printing inks, here for example textile printing, flexographic, decorative printing or gravure inks, electrophotographic toners and developers, such as, for example, one- or two-component powder toners (also referred to as one- or two-component developers), magnetic toners, liquid toners, latex toners, polymerization toners and also specialty toners, liquid inks, preferably inkjet inks, for example on an aqueous or nonaqueous (“solventborne”) basis, microemulsion inks, UV-curable inks and inks which operate according to the hotmelt process, inks for writing by utensils such as colored pencil leads, fiber tip pens, fine liner pens, felt tip pens, gel rollers, text markers or whiteboard markers, and insulating materials such as glass wool.

Furthermore, the pigment preparations of the invention are suitable for coloring macromolecular materials of all kinds, composed of natural and synthetic fiber materials, for example. Other applications are the coloring of sausage skins, seeds, fertilizers, glass, especially glass bottles, pavers, concrete, wood stains, waxes, paraffins, liquid inks, pastes for pens, chalks, laundry detergents and cleaning products, shoe care products, latex products, abrasives, for the spin coloring of viscose, and for the coloring of plastics or high molecular mass materials of all kinds.

High molecular mass organic materials are, for example, cellulose ethers and esters such as ethylcellulose, nitrocellulose, cellulose acetate or cellulose butyrate, natural resins or synthetic resins such as polymerization resins or condensation resins, amino resins for example, especially urea and melamine-formaldehyde resins, alkyd resins, acrylic resins, phenolic resins, polycarbonates, polyolefins such as polystyrene, polyvinyl chloride, polyethylene, polypropylene, polyacrylonitrile, polyacrylic esters, polyamides, polyurethanes or polyesters, rubber, casein, latices, silicone, individually or in a mixture.

The pigment preparations of the invention may also, furthermore, be used as colorants for color filters (“color filters”) for “flat screens”, both for additive and for subtractive color generation, and for “photoresists” as well, and as dyes for electronic inks (“electronic inks” or “e-inks”) or electronic paper (“electronic paper” or “e-paper”).

### Definitions

“Water-soluble” pertains to a material which at a concentration of 0.1 wt % at 25° C. has sufficient solubility to give a solution that is clear to the eye. The term “water-insoluble” pertains to a material which is not “water-soluble”.

“Monomer” denotes a discrete, unpolymerized chemical unit which in the presence of an initiator or of a suitable reaction generates a macromolecule, such as radical polymerization, for example. “Unit” denotes a monomer which has already been polymerized, i.e., which is part of a polymer.

“Polymer” denotes a chemical which is formed from the polymerization of one, two or more monomers. The term “polymer” encompasses all materials which originate from the polymerization of monomers, and also natural polymers. Polymers produced from only one monomer type are referred to as homopolymers. A polymer here comprises at least two monomer units. Polymers which are formed from two or more different kinds of monomer are referred to as copolymers. The distribution of the different monomers may be random, alternating or blockwise. In the case of the latter, “block copolymers” are then formed. Where the main chain of an existing polymer is functionalized with a further, different polymer, the products are referred to as “comb copolymers” or “graft copolymers”. The term “polymer” as used herein encompasses any kind of polymer, including homopolymers and copolymers.

### ABBREVIATIONS

C.I. “Color Index”
n.m. not measurable
NT not thixotropic, pigment preparation exhibited Newtonian behavior
LT slightly thixotropic, pigment preparation exhibits slight non-Newtonian behavior
T thixotropic, pigment preparation exhibits distinct non-Newtonian behavior

### EXAMPLES

### Constituents of the Illustrative Pigment Preparations

### Component (A)

### Organic Pigments

A1 Hansa Brilliant Yellow 2GX 70-S(C.I. Pigment Yellow 74, PY 74)
A2 Novoperm® Yellow HR 03 LV 5462 (C.I. Pigment Yellow 83, PY 83)
A3 Hostaperm® Violet RL 02 (C.I. Pigment Violet 23, PV 23)
A4 Permanent Red FGR (C.I. Pigment Red 112, PR 112)
A6 Hostaperm® Red D3G 70 (C.I. Pigment Red 254, PR 254)
A7 Hostaperm® Blue A4R (C.I. Pigment Blue 15:1, PB 15:1)
A8 Hostaperm® Blue B2G-EDS VP3491 (C.I. Pigment Blue 15:3, PB 15:3)
A9 Hostaperm® Green GNX (C.I. Pigment Green 7, PG 7)
A10 Printex® 300 (C.I. Pigment Black 7, PBk 7)

### Inorganic Pigments

A11 Bayferrox® 3920 (C.I. Pigment Yellow 42, PY 42)
A12 Sicopal® Orange L 2430 (C.I. Pigment Orange 82, PO 82)
A13 Sicopal® Yellow L 1100 (C.I. Pigment Yellow 184, PY 184)
A14 Bayferrox® Red 130M (C.I. Pigment Red 101, PR 101)
A15 Kronos® 2160 (C.I. Pigment White 6, PW 6)

### Dispersant Component (B)

B Random copolymer consisting of 49 mol % methacrylic acid and 51 mol % polyglycol MA750

### Dispersant Component (C)

C1 Branched block copolymer consisting of 1 mol % glycerol and 14 mol % styrene oxide and 85 mol % ethylene oxide (as in WO-2020152093)
C2 Graft copolymer consisting of the reaction product of a styrene/maleic anhydride copolymer (Cray Valley SMA 2000, ratio 2:1 styrene to maleic anhydride) with one equivalent of Jeffamine M-2005 (from Huntsman)

### Comparative Dispersants

VD1 Nuosperse® FX 600 (Elementis), a multi-functional, polymeric dispersant, recommended both for inorganic and organic pigments. Nuosperse FX 600 is a polymaleic ammonium salt, described in EP1599549B1.
VD2 Dispex® Ultra 4290 (BASF), a high molecular mass dispersant suitable for organic and inorganic pigments in aqueous preparations. Dispex Ultra 4290 is a high molecular mass dispersant/copolymer having an acid number of 9 mg KOH/g, presumably based on polyacrylate.
VD3 Dispersogen® LFS (Clariant), a dispersant containing anionic surfactants and intended for water-based pigment preparations, which is suitable for all pigments.
VD4 Dispersogen® ECS (Clariant), a dispersant containing anionic surfactants and intended for water-based pigment preparations, which is suitable for all pigments.
VD5 Tego® Dispers 750 W (Evonik) is a weakly anionic, polymeric wetting and dispersing additive for high-quality aqueous formulations. It has really good compatibility and is appropriate for all types of pigment, particularly for inorganic pigments.

The pigment preparations were produced either in a Lau Disperser or in a Dispermat.

### Production of a Pigment Preparation in the Lau Disperser:

The liquid components (deionized water, dispersant, additives) were homogenized using a shaker (e.g., Heidolph Unimax 2010). The pigment, either as powder, granules or presscake, was homogenized and predispersed subsequently together with the liquid premix, using a paint shaker (e.g., Lau Disperser DAS). The subsequent fine-dispersion was carried out using a paint shaker (e.g., Lau Disperser DAS), the grinding being carried out with glass beads of size d=3 mm in a defined running time of 60 minutes. The grinding media were removed using a centrifuge (e.g., Heraeus Multifuge 3s) and the pigment preparation was isolated.

### Production of a Pigment Preparation in the Dispermat:

The pigment was homogenized and predispersed either as powder, granules or presscake together with the dispersants and the other additives in deionized water, using a dissolver (e.g., from VMA Getzmann GmbH, type AE3-M1) or other suitable apparatus. The subsequent fine-dispersion was carried out using a bead mill (for example, using AE3-M1 from VMA-Getzmann GmbH) or other suitable dispersing unit, with the grinding being carried out using zirconium silicate or zirconium oxide beads of size d=1.2-1.4 mm until the color strength, color and transparency were as desired. The dispersion was then adjusted to the desired final pigment concentration with deionized water, the grinding media were removed, and the pigment preparation was isolated.

The pigment preparations described in the following examples (tables 1 and 2) were produced by the method described above, with the respective constituents being used in the reported quantities such as to give 100 parts of the respective pigment preparation. In all the examples, parts denote parts by weight.

### Characterization of a Pigment Preparation:

The viscosity was determined using a cone-plate viscosimeter (MCR 72) from Anton Paar GmbH at 20° C. (titanium cone: diameter 60 mm, 1°), with measurement of the relationship between the viscosity and the shear rate in a range between 0 and 200 s⁻¹. The viscosity of each sample was rated at a shear rate of 60 s⁻¹.

The color strength was determined on the basis of spectral measurements. For this purpose, a 2% reduction of the pastes in a white emulsion paint is produced. The reduction is applied to the test substrate using film-drawing knife coaters with a gap height of 120 μm and dried overnight. Using a spectrophotometer, the coloristic values of the color drawdowns are measured. From the coloristic values measured, the color strength is calculated according to ISO 787-26.

To assess the storage stability of the dispersions, the viscosity was measured directly after production of the preparation and after 14-day storage at 50° C. Additionally, the color strength of the sample thus stored was determined, relative to a sample stored at room temperature. In addition, the homogeneity and the sedimentation behavior of the stored sample were rated by determining the sediment formed and also liquid phase.

### Evaluation:

The evaluation is made on the basis of the following 4 parameters: thixotropy, stability, viscosity and color strength. Grading took place as described below: Thixotropy: NT=not thixotropic, the paste does not develop a structural viscosity, and so does not become more viscous or even solid under storage conditions. LT=slightly thixotropic, the paste develops an increased viscosity on storage or even becomes non-fluid. By the action of just a little energy in the form of shearing, for example, the paste can nevertheless be fluidized again. T=thixotropic, the paste solidifies under storage conditions and is no longer fluid, but becomes temporarily fluid when the input of energy is increased.

Stability: 3=the paste is homogeneous even over a storage period, developing neither liquid phase nor sedimentation. 2=the paste over the period of storage forms liquid phase on the surface or sediment on the base, that can easily be reagitated. 1=over the storage period, the paste forms two phases or develops a sediment on the base that is difficult or impossible to reagitate.

Viscosity: the evaluation of the viscosity is heavily dependent on the pigment being dispersed. The general objective is to produce a fluid pigment paste. Its viscosity is normally situated in a target range between 50 and 1000 mPa*s.

Color strength: the coloristic values were measured after 14 days of storage, against the values of a reference product. Color strengths at more than 100% are better than the reference. The exception are white pigment pastes—for these, values below 100% are better than the reference.

Comprehensive evaluation is made on the basis of the following four gradations:
Better: all parameters in the desired range (at least ˜OK), but better for the standard dispersants (standard dispersants used: Dispersogen LFS for organic and carbon black pigments, Dispersogen ECS for inorganic pigments)
OK: all parameters in the desired range, comparable with standard dispersant
Almost OK (˜OK): one parameter is not fulfilled (products frequently show slight thixotropy and are somewhat weaker in color than in products produced with standard dispersant);
Not OK (NOK): at least 2 parameters are not fulfilled (products exhibit high viscosity, problems with stability, and are significantly weaker in color than in products produced with standard dispersant)

TABLE 1
Results of the pigment pastes

| | | Pigment | | | | | Color strength | |
|---|---|---|---|---|---|---|---|---|
| | | concentration | Dispersant in | | | Viscosity | after | |
| Example | Pigment | in parts by weight | weight fractions | Thixotropy | Stability | (mPa*s) | 14 days | Evaluation |
| 1(V) | A1 | 50 | 6 VD5 | NT | 1 | 283 | 96.7 | NOK |
| 2(V) | A1 | 80 | 6 VD1 | T | 3 | 3058 | 77.7 | NOK |
| 3(V) | A1 | 50 | 6 VD2 | NT | 3 | 347 | 96.9 | OK |
| 5 | A1 | 50 | 5.5 B + 1.0 C2 | NT | 3 | 631 | 120.6 | Better |
| 6 | A1 | 50 | 2.2 B + 1.8 C1 | NT | 3 | 166 | 105.8 | Better |
| 7(V) | A2 | 35 | 8 VD5 | n.m. | n.m. | n.m. | n.m. | NOK, coagulates |
| 8(V) | A2 | 35 | 8 VD1 | NT | 3 | 105 | 88.0 | ~OK |
| 9(V) | A2 | 35 | 8 VD2 | NT | 2 | 123 | 99.2 | ~OK |
| 10 | A2 | 35 | 6 B + 2 C2 | NT | 3 | 90 | 92.8 | OK |
| 11 | A2 | 35 | 6.8 B + 1.2 C2 | NT | 3 | 92 | 91 | OK |
| 12 | A2 | 35 | 4.4 B + 3.6 C1 | NT | 3 | 71 | 93.7 | OK |
| 13(V) | A7 | 35 | 8 VD5 | n.m. | n.m. | n.m. | n.m. | NOK, coagulates |
| 14(V) | A7 | 35 | 8 VD1 | NT | 2 | 55 | 74.6 | NOK |
| 15(V) | A7 | 35 | 8 VD2 | NT | 3 | 218 | 84.1 | OK |
| 16 | A7 | 35 | 6 B + 2 C2 | NT | 3 | 450 | 86.3 | OK |
| 17 | A7 | 35 | 6.8 B + 1.2 C2 | NT | 3 | 478 | 89.5 | OK |
| 18 | A7 | 35 | 4.4 B + 3.6 C1 | NT | 3 | 359 | 87.0 | OK |
| 19(V) | A8 | 45 | 6 VD5 | n.m. | n.m. | n.m. | n.m. | NOK, coagulates |
| 20(V) | A8 | 45 | 6 VD1 | T | 3 | 2492 | 78.6 | NOK |
| 21(V) | A8 | 45 | 6 VD2 | NT | 3 | 175 | 74.1 | ~OK |
| 22 | A8 | 45 | 5.5 B + 1.0 C2 | NT | 3 | 274 | 82.6 | OK |
| 23 | A8 | 45 | 3.6 B + 2.9 C1 | NT | 3 | 274 | 79.1 | OK |
| 24(V) | A3 | 30 | 7 VD5 | T | 3 | 956 | 74.6 | NOK |
| 25(V) | A3 | 30 | 7 VD1 | NT | 2 | 29 | 89.0 | ~OK |
| 26(V) | A3 | 30 | 7 VD2 | NT | 2 | 37 | 84.2 | ~OK |
| 27 | A3 | 30 | 5.5 B + 1.0 C2 | NT | 3 | 89 | 84.3 | OK |
| 28 | A3 | 30 | 3.6 B + 2.9 C1 | NT | 3 | 136 | 87.7 | OK |
| 29(V) | A9 | 40 | 6 VD5 | n.m. | n.m. | n.m. | n.m. | NOK, coagulates |
| 30(V) | A9 | 40 | 6 VD1 | T | 3 | 253 | 79.0 | ~OK |
| 31(V) | A9 | 40 | 6 VD2 | NT | 1 | 145 | 91.3 | NOK |
| 32 | A9 | 40 | 6 B + 2 C2 | NT | 3 | 894 | 79.6 | OK |
| 33 | A9 | 40 | 5.1 B + 0.9 C2 | NT | 3 | 631 | 80.3 | OK |
| 34 | A9 | 40 | 4.4 B + 3.6 C1 | NT | 3 | 582 | 81.9 | OK |
| 25(V) | A4 | 45 | 6 VD5 | NT | 1 | 268 | 59.5 | NOK |
| 36(V) | A4 | 45 | 6 VD1 | T | 3 | 652 | 82.0 | ~OK |
| 37(V) | A4 | 45 | 6 VD2 | NT | 3 | 311 | 63.7 | ~OK |
| 38 | A4 | 45 | 4.5 B + 1.5 C2 | NT | 3 | 891 | 80.6 | OK |
| 39 | A4 | 45 | 5.1 B + 0.9 C2 | NT | 3 | 932 | 81.8 | OK |
| 40 | A4 | 45 | 3.3 B + 2.7 C1 | NT | 3 | 799 | 89.3 | OK |
| 41(V) | A10 | 35 | 7 VD5 | n.m | n.m. | n.m. | n.m. | NOK, coagulates |
| 42(V) | A10 | 35 | 7 VD1 | NT | 2 | 453 | 83.8 | ~OK |
| 43(V) | A10 | 35 | 7 VD2 | NT | 3 | 70 | 91.0 | OK |
| 44 | A10 | 35 | 5.5 B + 1 C2 | NT | 3 | 77 | 91.2 | OK |
| 45 | A10 | 35 | 3.6 B + 2.9 C1 | NT | 3 | 68 | 92.3 | OK |
| 46(V) | A14 | 60 | 4 VD5 | NT | 1 | n.m. | n.m. | NOK |
| 47(V) | A14 | 60 | 4 VD1 | T | 3 | 336 | 99.7 | ~OK |
| 48(V) | A14 | 60 | 4 VD2 | NT | 1 | n.m. | n.m. | NOK |
| 49 | A14 | 65 | 3B + 1 C2 | NT | 2 | 237 | 106.5 | better |
| 50 | A14 | 65 | 3.4 B + 0.6 C2 | NT | 2 | 191 | 106.5 | better |
| 51 | A14 | 65 | 2.2 B + 1.8 C1 | NT | 2 | 148 | 105.9 | better |
| 52(V) | A11 | 55 | 6 VD5 | n.m. | n.m. | n.m. | n.m. | NOK, coagulates |
| 53(V) | A11 | 55 | 6 VD1 | n.m. | n.m. | n.m. | n.m. | NOK, coagulates |
| 54(V) | A11 | 55 | 6 VD2 | NT | 2 | 179 | 100.1 | ~OK |
| 55 | A11 | 55 | 1.7 B + 1.3 C2 | NT | 3 | 265 | 101.9 | better |
| 56 | A11 | 55 | 2.6 B + 0.4 C1 | NT | 3 | 299 | 99.8 | better |
| 57(V) | A15 | 65 | 4 VD5 | NT | 1 | 225 | 109.8 | NOK |
| 58(V) | A15 | 65 | 6 VD5 | NT | 2 | 327 | 113.8 | better |
| 59(V) | A15 | 66 | 4 VD1 | T | 3 | 635 | 107.1 | ~OK |
| 60(V) | A15 | 65 | 4 VD2 | n.m. | n.m. | n.m. | n.m. | NOK |
| 61(V) | A15 | 65 | 8 VD2 | NT | 1 | 350 | 114.2 | NOK |
| 62 | A15 | 65 | 4.5 B + 1.5 C2 | NT | 2 | 372 | 114.6 | better |
| 63 | A15 | 65 | 3.4 B + 0.6 C2 | NT | 2 | 169 | 111.4 | better |
| 64 | A15 | 65 | 5.5 B + 1 C2 | LT | 3 | 443 | 112.7 | better |
| 65 | A15 | 65 | 3.6 B + 2.9 C1 | NT | 3 | 350 | 111.5 | better |

[V = comparative]

To all of the examples in table 1, 10.0 parts of component (E, propylene glycol). 0.2 parts of component (F, preservative), 0.3 parts of component (G, defoamer) and compensatory component (H, deionized water) were added.

The numerical values from the examples of table 1 clearly show the improved and above all universal performance of the mixtures of the invention in comparison to known universal dispersants which are available commercially.

### Examples 133-135

TABLE 2
Synergetic effects in pigment pastes

| | | | | | | | Color | |
|---|---|---|---|---|---|---|---|---|
| | | Pigment | | | | | strength | |
| | | concentration | Dispersant in | | | Viscosity | after | |
| Example | Pigment | in parts by weight | weight fractions | trixotropy | Stability | mPa*s | 14 days | Evaluation |
| 66(V) | A1 | 50 | 6 C2 | NT | 3 | 459 | 91.3 | OK |
| 67(V) | A1 | 50 | 6 C1 | NT | 3 | 399 | 98.3 | OK |
| 68(V) | A1 | 50 | 6 B | NT | 2 | 12030 | 75.4 | NOK |
| 6 | A1 | 50 | 5.5 B + 1.0 C2 | NT | 3 | 631 | 120.6 | Better |
| 8 | A1 | 50 | 2.2 B + 1.8 C1 | NT | 3 | 1 [symbol] | 105.8 | Better |
| 69(V) | A4 | 45 | 6 C2 | NT | 3 | 293 | 74.5 | ~OK |
| 70(V) | A4 | 45 | 6 C1 | NT | 3 | 172 | 87.4 | OK |
| 71(V) | A4 | 45 | 6 B | NT | 3 | 381 | 62.0 | NOK |
| 38 | A4 | 45 | 4. [symbol] B + 1.6 C2 | NT | 3 | 891 | 80.6 | OK |
| 39 | A4 | 45 | 5.1 B + 0.9 C2 | NT | 3 | 932 | 81.8 | OK |
| 40 | A4 | 45 | 3.3 B + 2.7 C1 | NT | 3 | 799 | 89.3 | OK |
| 72(V) | A10 | 35 | 7 C2 | NT | 3 | 83 | 86.7 | ~OK |
| 73(V) | A10 | 35 | 7 C1 | NT | 3 | 59 | 82.7 | ~OK |
| 74(V) | A10 | 35 | 7 B | NT | 3 | 83 | 75.9 | ~OK |
| 44 | A10 | 35 | 6.6 B + 1 C2 | NT | 3 | 77 | 91.2 | OK |
| 45 | A10 | 35 | 3. B + 2.9 C1 | NT | 3 | 68 | 92.3 | OK |
| 75(V) | A11 | 55 | 6 C2 | LT | 3 | 1220 | 96.2 | ~OK |
| 76(V) | A11 | 55 | 6 C1 | n.m. | n.m. | n.m. | n.m. | NOK |
| 77(V) | A11 | 55 | 6 B | NT | 2 | 293 | [symbol] | ~OK |
| 56 | A11 | 55 | 1.7 B + 1.3 C2 | NT | 3 | 265 | 101.9 | better |
| 56 | A11 | 55 | 2.6B + 0.4 C1 | NT | 3 | 299 | 99.8 | better |

[V = comparative] [symbol]
indicates data missing or illegible when filed

The numerical values from the examples of table 2 show clearly that the mixtures of the invention also have synergistic effects which were not foreseeable from the individual components. Hence the pigment preparation of the organic Pigment Yellow PY 74 (A1) with B2 exhibited severe incompatibility and a high viscosity. Products with C2 did have an OK evaluation, but exhibited a slight weakness in color. A mixture of B2/C2 in a mass ratio of 85/15 produces a stable pigment preparation having very low viscosity and very good compatibility in conjunction with greatly improved color strength. For other organic pigments such as Pigment Red PR 112 (A4), and carbon black (A10) and for the inorganic pigment PY 42 (A11), for example, similar synergistic effects can be observed.

1-19. (canceled)

20. A pigment preparation comprising
(A) at least one organic and/or inorganic pigment and/or filler;
(B) at least one anionic copolymer as dispersant, which contains
(I) 40 to 95 mol % od structural units of an anionic monomer selected from the group of consisting of acrylic acid, methacrylic acid, itaconic acid, 2-carboxyethylacrylic acid, maleic acid, mixtures thereof and their respective salts, and
(II) 5 to 60 mol % of structural units of a monomer having repeat units of formula (B1) 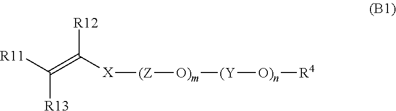
in which
R11, R12, and R13 independently of one another are selected from the group consisting of H, methyl and ethyl,
R4 is H or an alkyl group having 1 to 4 carbon atoms,
X is selected from the group consisting of O, COO, CONH, CH₂O, and CH₂CH₂O,
Y is an ethylene group
Z is a propylene group, a butylene group or a phenylethylene group,
m is an integer from 0 to 100,
n is a integer from 1 to 100, and
m+n is than 5, and
(C) at least one nonionic copolymer, which contains at least one structural unit having aromatic groups and at least one structural unit having polyethylene glycol groups, and
(H) water.

21. The pigment preparation as claimed in claim 1, wherein the structural unit (I) of (B) is acrylic acid or methacrylic acid, or salts thereof.

22. The pigment preparation as claimed in claim 1, wherein the fraction of the structural units (I) is fro 45 to 85 mol %.

23. The pigment preparation as claimed in claim 1, wherein the fraction of the structural units (II) is from 15 to 55 mol %.

24. The pigment preparation as claimed in claim 1, in which R11, R12 and R13 independently of one another are selected from the group consisting of H and methyl.

25. The pigment preparation as claimed in claim 1, wherein R12 is methyl and R11 and R13 are H.

26. The pigment preparation as claimed in claim 1, wherein is H or a methyl group.

27. The pigment preparation as claimed in claim 1, wherein X is O or C(O)O.

28. The pigment preparation as claimed in claim 1, wherein Z is propylene or phenylethylene.

29. The pigment preparation as claimed in claim 1, wherein m is an integer from 1 to 10.

30. The pigment preparation as claimed in claim 1, wherein n is an integer from 5 to 45.

31. The pigment preparation as claimed in claim 1, wherein (m+n) is an integer from 8 to 49.

32. The pigment preparation as claimed in claim 1, wherein the copolymer (C) comprises not only at least one structural unit having polyoxyethylene groups but also a structural unit having aromatic groups which derive from styrene oxide.

33. The pigment preparation as claimed in claim 1, wherein the copolymers (C) correspond to the formula (3), to the formula (4), or to mixtures thereof 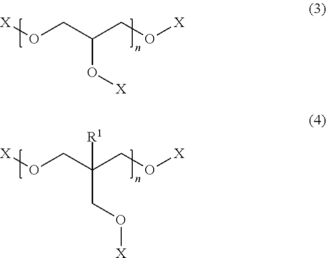
where
n is an integer greater than or equal to 1,
R¹ is an aliphatic linear or branched hydrocarbon radical having 1 to 10 carbon atoms, a hydrogen atom, the structural unit —O—X, or the structural unit —CH₂—O—X,
X corresponds to the formula (5) 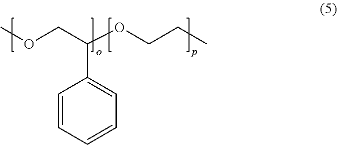
in which
o is an Integer from 1 to 50,
p is an Integer from 1 to 200, and
(o+p) is greater than 2.

34. The pigment preparation as claimed in claim 1, wherein the copolymers (C) correspond to the formula (6) 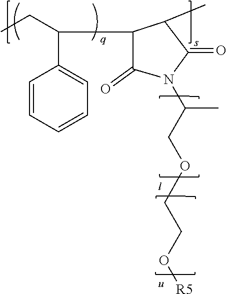
in which
q is an integer from 1 to 4,
s is an integer from 5 to 50,
R5 is H or an alkyl group having 1 to 4 carbon atoms,
t is an integer from 0 to 10,
u is an integer from 1 to 100, and
t+u is greater than 10.

35. The pigment preparation as claimed in claim 1, comprising 5 to 80 wt % of component (A).

36. The pigment preparation as claimed in claim 1, comprising 1 to 20 wt % of component (B).

37. The pigment preparation as claimed in claim 1, comprising 1 to 20 wt % of component (C).

38. A method of producing a pigment preparation comprising (A) at least one organic and/or inorganic pigment and/or filler ater the method comprising the step of combining polymers (B) and (C) as dispersant wherein
(B) is an anionic copolymer which contains
(I) 40 to 95 mol % of structural units of an anionic monomer selected from the group consisting of acrylic acid, methacrylic acid, itaconic acid, 2-carboxyethylacrylic acid maleic acid, mixtures thereof and their respective salts, and
(II) 5 to 60 mol % of structural units of a monomer having repeat units of formula (B1) 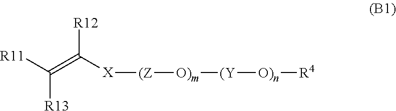
in which
R11, R12 and R13 independently of one another are selected from the group consisting of H, methyl and ethyl,
R4 is H or an alkyl group having 1 to 4 carbon atoms,
X is selected from the group consisting of O, COO, CONH, CH₂O and CH₂CH₂O,
Y is an ethylene group
Z is a propylene group, a butylene group or a phenylethylene group,
m is an integer from 0 to 100,
n is an integer from 1 to 100, and
m+n is greater than 5, and
(C) is a nonionic copolymer, which contains at least one structural unit having aromatic groups and at least one structural unit having polyethylene glycol groups.
